(19) United States
(12) Patent Application Publication
(10) Pub. No.: US 2024/0129340 A1
(43) Pub. Date: Apr. 18, 2024

(54) METHODS AND SYSTEMS FOR CLOUD SECURITY OPERATIONS

(71) Applicants: RATHINASABAPATHY RAMASWAMY, Seattle, WA (US); SIVARAMASUBRAMANIAN KAILASAM, CHENNAI (IN)

(72) Inventors: RATHINASABAPATHY RAMASWAMY, Seattle, WA (US); SIVARAMASUBRAMANIAN KAILASAM, CHENNAI (IN)

(21) Appl. No.: 18/239,102

(22) Filed: Aug. 28, 2023

Related U.S. Application Data
(60) Provisional application No. 63/523,111, filed on Jun. 26, 2023.
(60) Provisional application No. 63/402,179, filed on Aug. 30, 2022.
(60) Provisional application No. 63/402,300, filed on Aug. 30, 2022.
(60) Provisional application No. 63/402,328, filed on Aug. 30, 2022.
(60) Provisional application No. 63/402,339, filed on Aug. 30, 2022.
(60) Provisional application No. 63/402,365, filed on Aug. 30, 2022.
(60) Provisional application No. 63/402,295, filed on Aug. 30, 2022.
(60) Provisional application No. 63/402,313, filed on Aug. 30, 2022.
(60) Provisional application No. 63/402,356, filed on Aug. 30, 2022.
(60) Provisional application No. 63/402,407, filed on Aug. 30, 2022.
(60) Provisional application No. 63/402,161, filed on Aug. 30, 2022.
(60) Provisional application No. 63/402,168, filed on Aug. 30, 2022.
(60) Provisional application No. 63/402,201, filed on Aug. 30, 2022.
(60) Provisional application No. 63/402,213, filed on Aug. 30, 2022.

(51) Int. Cl. H04L 9/40

(52) U.S. Cl. CPC H04L 63/20; H04L 63/10; H04L 63/1433

(57) ABSTRACT

In one aspect, a computerized method for implementing a plurality of cloud-based SecOps for one or more cloud-computing platforms comprising: maintaining a plurality of cloud-based SecOps compliance rules; determining a SecOps compliance posture based on the plurality of cloud-based SecOps compliance rules; implementing a security posture based, in part, on the cloud-based SecOps compliance; implementing a plurality of continuous checks on a security posture of the plurality of cloud accounts, wherein the security posture provides visibility on a plurality of aspects across each cloud-based account.

### CLAIM OF PRIORITY

This application claims priority to U.S. Provisional Patent Application No. 63/523,111, filed on Jun. 26, 2023 and titled METHODS AND SYSTEMS FOR CLOUD SECURITY OPERATIONS. This provisional patent application is hereby incorporated by reference in its entirety.

### BACKGROUND

Security and Compliance rapidly evolving in Cloud world. Unlike the traditional systems, physical and boundary protection is no longer sufficient in protecting the assets provisioned in the cloud.

In addition to that Compliance regulations and Industry benchmarks are redefined every year and cloud assets need to adhere to the newer regulations and industry benchmarks to safeguard their customer information and reputation.

Additionally, there is a need to continuously monitor compliance controls, security threats and vulnerabilities across the assets provisioned in multi-cloud environments.

Additionally, it is noted that the cloud lies at the heart of digital transformation. However, it is impossible to unleash the real benefits of the cloud without continuous compliance and security posture. Organizations struggle with operational complexities, security and regulatory compliance, and unabated cloud costs. There is a need to overcome these challenges with deeper cloud visibility, security guardrails, and automatic remediation. There is a need for solutions that can be built on cloud-native services. There is a need for solutions to use a unique Abstracted Cloud Compliance (AC3) approach which uses abstraction of the well know industry standards, compliance standard and industry benchmarks, and a patented cloud SecOps technology.

### SUMMARY OF THE INVENTION

In one aspect, a computerized method for implementing a plurality of cloud-based SecOps for one or more cloud-computing platforms comprising: maintaining a plurality of cloud-based SecOps compliance rules; determining a SecOps compliance posture based on the plurality of cloud-based SecOps compliance rules; implementing a security posture based, in part, on the cloud-based SecOps compliance; implementing a plurality of continuous checks on a security posture of the plurality of cloud accounts, wherein the security posture provides visibility on a plurality of aspects across each cloud-based account; determining and providing a threat security posture; implementing an inventory posture for visibility operations by providing a visibility and control over a plurality of cloud-based resources spread across each entity's cloud-based account by automatically discovering plurality of cloud-based resources as a cloud-based inventory of each entity's cloud-based accounts that are on-boarded into the cloud-computing platform; and implementing an access posture, wherein the access posture is used to provide a right access to a correct entity for one or more assets in each entity's cloud-based account.

### BRIEF DESCRIPTION OF THE DRAWINGS

FIG. 1 illustrates an example process for implementing cloud security operations, according to some embodiments.

FIG. 2 provides a schematic view of a cloud-based security operations system 200, according to some embodiments.

FIG. 3 illustrates an example process for implementing cloud-based SecOps, according to some embodiments.

FIG. 4 illustrates an example SecOps framework, according to some embodiments.

FIG. 6 illustrates an example schema for implementing inventory visibility, according to some embodiments.

FIG. 7 is a diagram representing the interaction of functions relevant to reports, according to some embodiments.

FIG. 8 illustrates an example SecOps deployment architecture, according to some embodiments.

FIG. 9 illustrates an example SecOps process, according to some embodiments.

FIG. 10 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for cloud-based security operations. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Amazon Web Services, Inc. (AWS) is an on-demand cloud computing platform(s) and API( )s. These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (SaaS), platform as a service (PaaS) and infrastructure as a service (IaaS) and supports many different programming languages, tools, and frameworks, including both Microsoft-specific and third-party software and systems.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Cyber security is the protection of computer systems and networks from information disclosure, theft of, or damage to their hardware, software, or electronic data, as well as from the disruption or misdirection of the services they provide.

Identity and access management (IAM) can be a framework of policies and technologies to ensure that the right users (e.g. that are part of the ecosystem connected to or within an enterprise) have the appropriate access to technology resources. IAM systems are part of an IT security and data management schema. IAM systems can not only identify, authenticate, and control access for individuals who will be utilizing IT resources but also the hardware and applications employees need to access.

RabbitMQ is an open-source message-broker software that originally implemented the Advanced Message Queuing Protocol (AMQP) and has since been extended with a plug-in architecture to support Streaming Text Oriented Messaging Protocol (STOMP), MQ Telemetry Transport (MQTT), and other protocols.

Security Operations (SecOps) combines information technology (IT) security and operations methods and can integrates tools, processes, and technology to maintain security and reduce risk. Cloud SecOps can be an important function for providing robust and effective security for cloud-based infrastructure. Cloud-based SecOps for cloud-based systems/services can be different from traditional infrastructure security function as it can handle security for multiple cloud-based services, components, and resources. Cloud-based systems can provide agility and hence there is potential increased security risk. Cloud-based SecOps covers people, process, technology, services, and/or tools needed to identify and manage threat exposure, ensure compliance and to prevent, detect and respond to cybersecurity incidents cloud-based SecOps brings to obtain cloud-based operations, security and compliance to better coordinate priorities and optimize communication, while integrating automation to ensure fast and secure software delivery which is compliant with regulatory and compliance standards. Cloud-based SecOps can use a compliance controls and policy (e.g. detective guardrails) execution framework which enables to automate the compliance controls and policies which will run against the resources deployed in the multi cloud environment. The compliance controls and policy execution framework uses multiple technical components such as converged policy engine, abstracted cloud compliance framework, compliance BOT, inventor visibility, access visibility and reports.

Example Systems and Methods

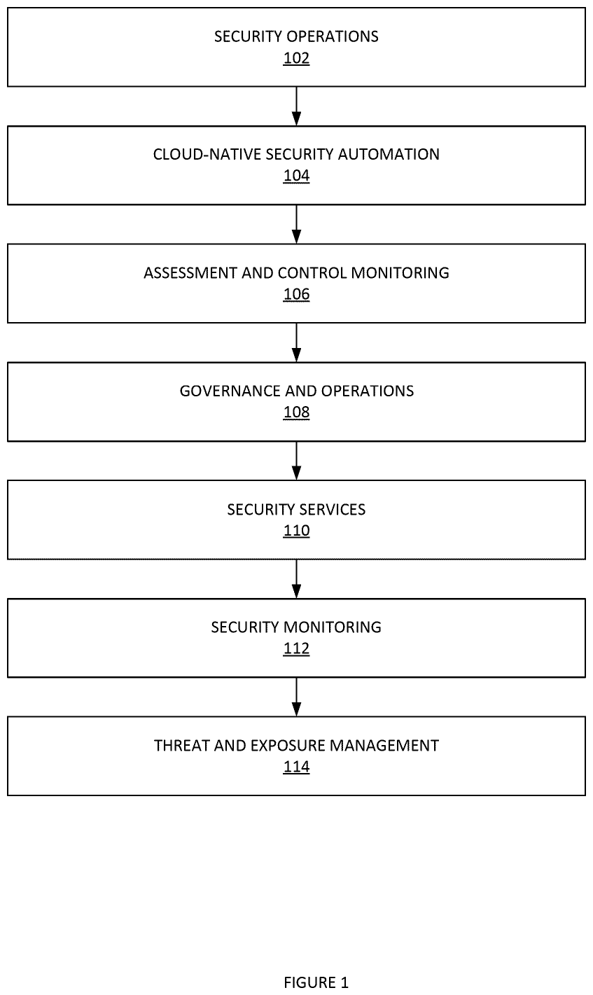

FIG. 1 illustrates an example process 100 for implementing cloud security operations, according to some embodiments.

In step 102, process 100 implements security operations. Process 100 can provide various design considerations and operational procedures required to create an operational security function to assist with threat visibility and risk reduction.

In step 104, process 100 implements cloud-native security automation. Process 100 can identify cloud native security and third-party tools required to meet the security guidelines and define operational procedures for utilizing the services and tools.

In step 106, process 100 implements compliance assessment and control monitoring. Process 100 can align with enterprise compliance needs as per industry and regulatory needs. Process 100 can establish control monitoring and assessment cycles required.

In step 108, process 100 implements governance and operations. Process 1000 can establish security teams and governing procedures to ensure the success of soc operations and their promotion through effective metric reporting.

In step 110, process 100 implements security services. Process 100 can establish requirements and criteria to identify, select, engage, and work with service providers that can deliver continuous and on-demand SecOps capabilities.

In step 112, process 100 implements security monitoring, detection and response technologies. Process 100 can establish requirements for selecting, deploying, operating, and maintaining security monitoring, detection, and response (SMDR) technologies and solutions.

In step 114, process 100 implements threat and exposure management. Process 100 can manage system and asset exposure, across the environments in which business and IT units operate, that could lead to cybersecurity incidents.

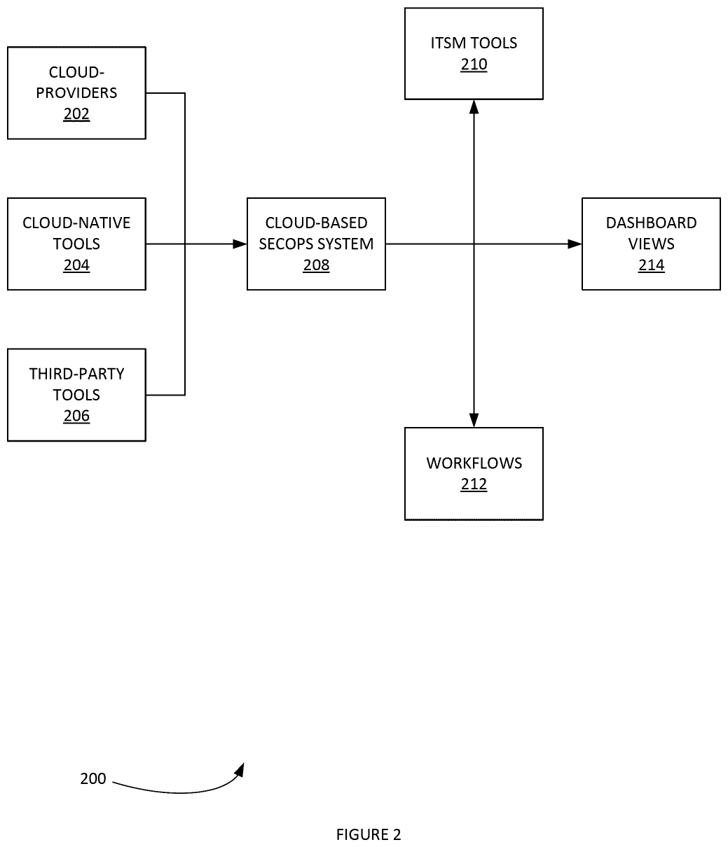

FIG. 2 provides a schematic view of a cloud-based security operations system 200, according to some embodiments. Cloud-based security operations system 200 can include cloud based SecOps system 208. Cloud based SecOps system 208 can implement third-party tools integration. Cloud based SecOps system 208 can obtain data from, inter alia: cloud providers 202, cloud native tools 204, third party tools 206, etc. This data would be analyzed and provided as actionable insights by cloud based SecOps system 208. Cloud based SecOps system 208 can implement cloud native tools integration. Cloud based SecOps system 208 can pull the data from cloud native tools which scans for guest level vulnerabilities and threat events. This data would be analyzed and provided as actionable insights. Cloud-based SecOps system 208 can provide the solution to integrate the third-party vulnerability solution which provides guest level vulnerabilities.

Cloud-based security operations system 200 also includes, inter alia: ITSM tools 210, workflows 212, and dashboard views 214. ITSM tools 210 provides ITSM Integration. In this way, cloud-based security operations system 200 provides the solution to integrate the ITSM tool. This enables the customers to obtain the service tickets for fixing the misconfiguration findings or vulnerability findings.

Workflows 212 are provided. Workflows 212 can trigger the workload assessments and set the scope for the assessments. Cloud-based SecOps system 208 can manage dashboard views 214.

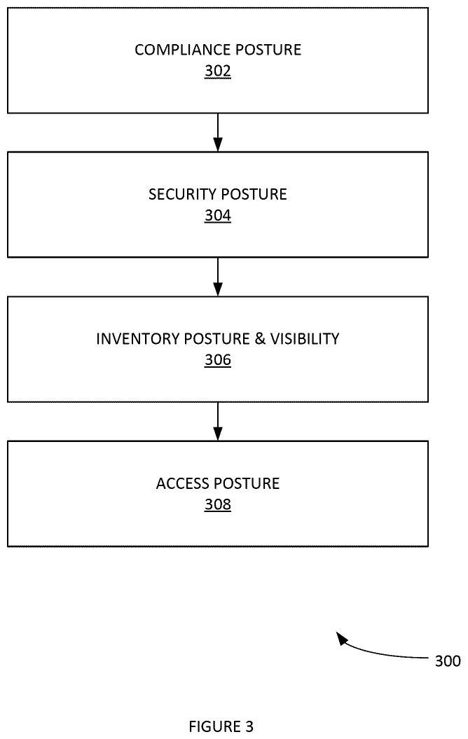

FIG. 3 illustrates an example process 300 for implementing cloud-based SecOps, according to some embodiments. In step 302, process 300 can determine a compliance posture. Cloud compliance operations can provide the following objectives. Step 302 can maintain compliance and configuration standards. Step 302 can maintain security posture for the resources provisioned. Step 302 can manage and activate policies to optimize resource utilization.

In step 302, process 300 can set up the compliance standards, compliance controls for each standard, classify the controls to manual or automated controls and then assess the automated controls through the guardrails and policies (e.g. compliance rules) to obtain the continuous compliance posture of each cloud account.

Compliance rules can enable process 300 to assess security of cloud-based infrastructure and application using cloud platform's native security assessment tools or third-party assessment tools. An operations team can obtain consolidated compliance posture in the dashboard to act on. Step 302 can enable users to do the assessment at standard level and/or control level or policy level. Each control can be reassessed at any time after remediating the violations.

In step 304, process 300 can implement a security posture. This can be based, in part, on the compliance rules of step 302. Process 300 can implement continuous checks on the security posture of your cloud accounts which are essential to have a secure cloud-computing environment. The security posture provides visibility on the following three aspects across a cloud-based accounts. The summary section provides the consolidated counts across the accounts and the grid provides account wise details.

Step 304 can determine and provide a threat security posture. These can include security alerts and threats that originate from the cloud native threat management services (e.g. AWS GuardDuty®, Azure Security Center®, etc. can be consolidated and displayed here).

Step 304 can determine and provide a vulnerabilities security posture. These are the result of vulnerability assessments of the workloads running in a cloud-computing platform (e.g. as a part of a cyber security programs, etc.). These vulnerabilities can be fetched from cloud-native services (e.g. including AWS Inspector®, Azure Security Center® across a set of specified cloud-based accounts).

Step 304 can determine and provide a guardrail findings security posture. The guardrails are rules governing the security best practices for a cloud resource. These are policy violations identified in a set of specified cloud-based accounts based on the guardrails configured for the accounts. These guardrails can include industry standards and best practices (e.g. including those recommended by AWS®, Azure®, etc.). Any violations to such checks can be listed here so that appropriate actions can be taken.

In step 306, process 300 can implement inventory posture and visibility operations. Step 306 can provide visibility and control over the various resources spread across an entity's cloud-based accounts. Step 306 can be used for observability and control. Process 300 can automatically discover the cloud-based inventory of the cloud-based accounts that are on-boarded. In turn, process 300 can provide a consolidated view of your inventory. Process 300 can provide a complete asset view about discovered resources, configurations of each resource and perspectives such as application level, cost level and so on.

In step 308, process 300 can implement an access posture. Step 308 can be used to address an organization's need(s) to provide the right access to right people for their assets. Step 308 can provide full access to an asset where it is not required and can pose a risk for misuse of privileges. It is noted that not having a correct access may prevent a user from performing business operations. Accordingly, process 300 provides an access governance posture. In this way, there can be visibility on any access related violations to standards and best practices. While managing multiple cloud accounts across cloud platforms, it is critical to have visibility on such non-compliant access and restrict them in time.

Process 300 can provide an access posture of cloud-identity resources such as, inter alia: IAM (Identity Access Management) users, IAM roles and IAM groups against a set of access best practices and standards. The access best practices can include, inter alia: reviewing idle users, idle roles, permissions within the roles, multifactor authentication, renewal of credentials, strength of the credentials and so on.

Example Systems

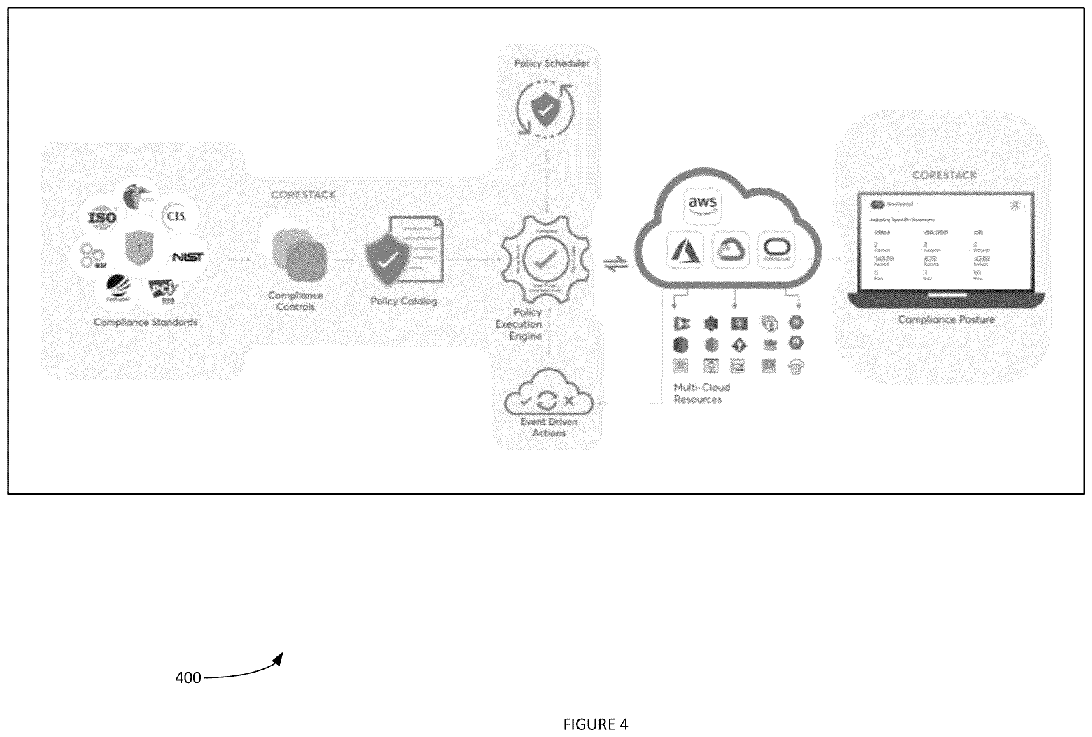

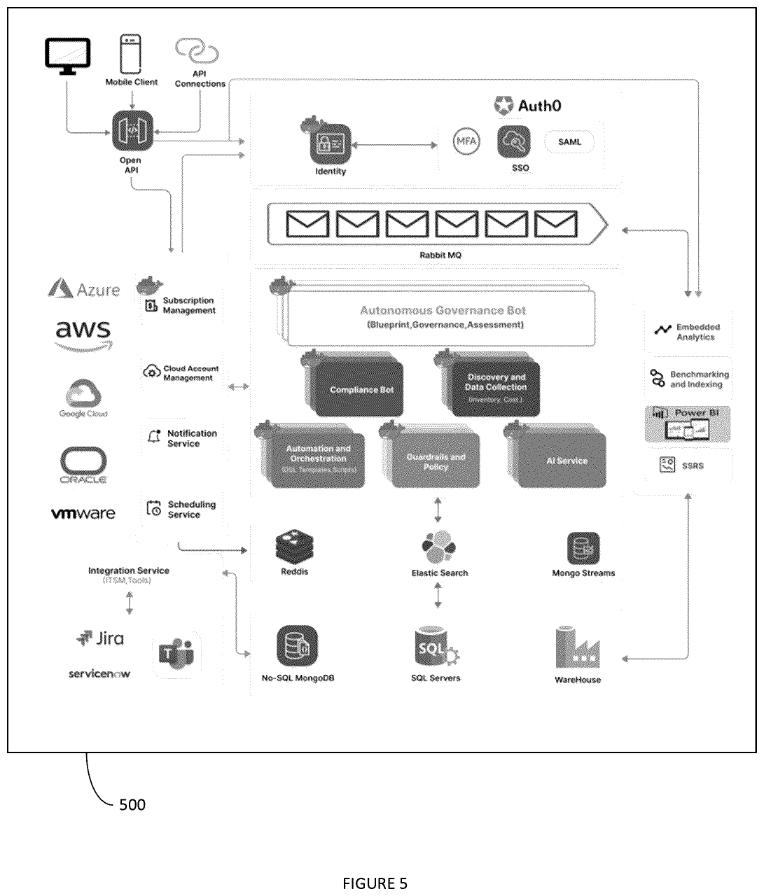

FIG. 4 illustrates an example SecOps framework 400, according to some embodiments. SecOps framework 400 can define, inter alia: compliance standards, individual controls, maps with policy catalog, etc. SecOps framework 400 can include a policy execution engine and compliance BOT. Policy execution engine and compliance BOT can fix the scheduled jobs for compliance and security assessment and then execute the respective policies. The Compliance and Security posture can be presented in dashboard and reports.

FIG. 5 illustrates an architecture of an example SecOps system 500, according to some embodiments. SecOps system 500 can include various systems, such as: database(s), web server(s), messaging system(s), daemon(s), etc.

SecOps system 500 can include a compliance BOT. Compliance BOT can be an independent daemon which is subscribed to a queue to process assessment requests. The input source for the compliance bot comes from the queue instead of collection.

SecOps system 500 can include various inputs such as, inter alia: Compliance_assessment_queue, Assessmentjob_id, Assement_type, Compliance_standard, Tenantid, PolicyID, Service, ServiceaccountID, PolicyID, Region, etc.

SecOps system 500 can implement various policies such as, inter alia: Call Policy(s), Execution Engine(s) with Cloud Account(s), Policy(s), Regions, Default parameter(s), etc.

The execution of Assessment and Policy to be persisted on Compliance_control_audit_trail. SecOps system 500 can maintain all execution of the assessment. The result can be updated in Compliance_control_status.

SecOps system 500 can include a converged policy engine. The policy engine supports policies (e.g. technical rules) developed for multi-cloud-based services. The policy engine developed for each cloud service. The policy engine is developed for native cloud policies as well as cloud service APIs. Additional policy engines can be included for databases. The following services are supported through various policy engines.

| Service | Engine type | Description |
|---|---|---|
| All services | Corestack | It supports all cloud service |
| | | APIs through python |
| AWS | Config, Organization | It supports AWS config policies |
| | | and SCP policies |
| Azure | Azure | It supports Azure policies |
| GCP | gcp_organization, | It supports GCP policies |
| | gcp_policy | |
| Oracle Cloud | oracle_cloud_guard | It support Oracle cloud policies |
| Guest level | Checf_inspec | It supports host level policies |

Example AWS® configurations are now discussed for SecOps system 500. AWS configurations can provide a detailed view of the configuration of various AWS resources in an AWS account. With AWS configurations, SecOps system 500 can ensure compliance with internal policies and best practices. SecOps system 500 can do this by creating AWS configuration policies, which represent an idealized configuration settings. It is noted that AWS is used herein by way of example.

AWS organization is now discussed. AWS organization policy helps SecOps system 500 to manage AWS resources and permissions required.

Azure® policy engine is now discussed. SecOps system 500 can include an azure policy engine. In the azure policy engine, policies related to an Azure® cloud are being executed. Azure policy engine can enforce organizational standards and assess compliance at-scale. Azure policy engine can evaluate resources in Azure® by comparing the properties of those resources to business rules.

Chef InSpec now discussed. Chef InSpec is an open-source framework for testing and auditing your applications and infrastructure. Chef InSpec can be a run-time framework and rule language used to specify compliance, security, and policy requirements. Chef InSpec can compare the actual state of SecOps system 500 with a desired state that you express in easy-to-read and easy-to-write Chef InSpec code. Chef InSpec detects violations and displays findings in the form of a report and puts you in control of remediation.

The corestack_policy engine is now discussed. In the corestack_policy engine, policies related to cloud-platforms (e.g. AWS, AZURE, GCP) are being executed. The execution of an SecOps system's policy is done on the corestack_policy engine as a separate engine where it happens on a common policy_executor for other policy types. Executing the SecOps system's policy is straight forward, the flow can be changed according to the service_name of the cloud (e.g. GCP, AZURE, AWS) and acquire respective details like authentication, policy_type, query_source, etc. and starts validating the policy to detect violations.

Execution flow can depend on the policy_type and connector_engine (SQL, MongoDB, etc.) of the policy content and starts execution on respective engines.

In one example, GCP and/or Oracle policies are using the native policies.

Cloud Native Service Integration by SecOps system 500 is now discussed. SecOps system 500 can be integrated with various cloud-native vulnerability and threat management tools. These can include, inter alia: AWS inspector, Qualys with Azure Defender, Azure Cloud defender, AWS Guard duty, etc. The vulnerability and threat management findings can be captured from these cloud native tools and persisted in databases of SecOps system 500. The SecOps system 500 can provide dashboards and reports to provide the visibility and insights to the users.

Third party tools integration can be performed by SecOps system 500. SecOps system 500 can be integrated with third party vulnerability tools (e.g. such as Quays and Nessus). The vulnerability findings are captured from these tools and persisted in SecOps system 500 databases. The dashboards and reports can provide the visibility and insights to the users.

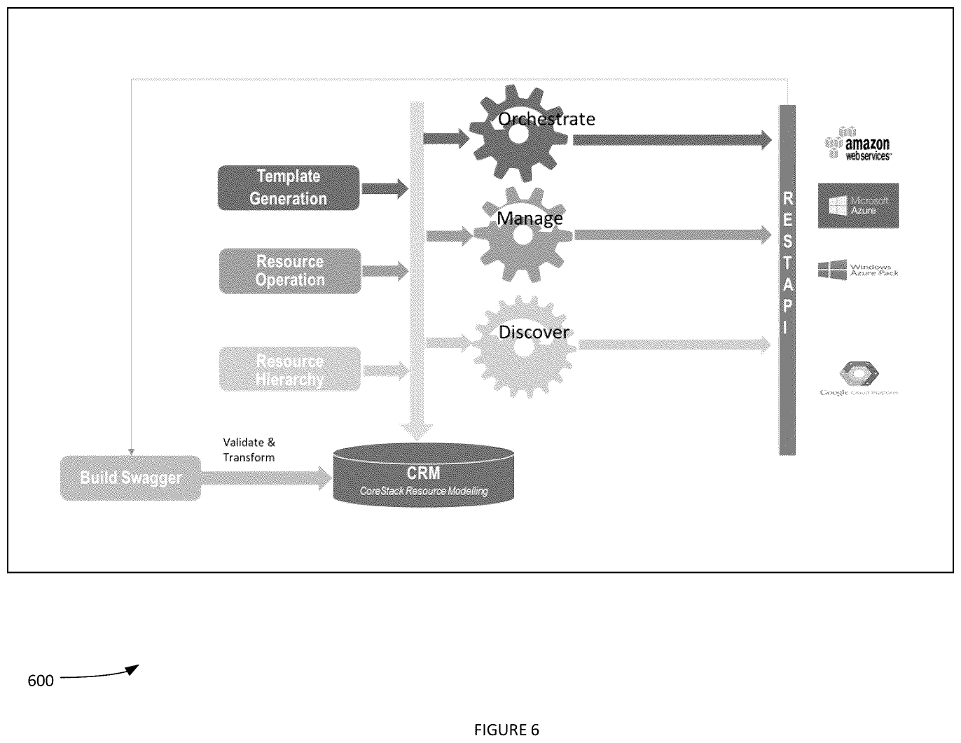

FIG. 6 illustrates an example schema 600 for implementing inventory visibility, according to some embodiments. An inventory visibility functionality in SecOps system 500 can provide a complete asset view about discovered resources, configurations of each resource and perspectives such as application level, cost level and so on. The inventory visibility functionality performs resource discovery, orchestration and management of cloud-based services using standard declarative definitions without a need for a plugin.

Access Visibility in SecOps system 500 is now discussed. In SecOps system 500, access to cloud-based resources (e.g. compute, storage, network and service) can be governed for confidentiality, integrity, and availability. Various principles are available to restrict access to resource(s). SecOps system 500 can use the principle of least privilege. Secure cloud-based resources (e.g. compute, storage, network and services) are primary tasks for any managed services. This can be done using ‘access visibility’. Access visibility can provide SecOps system 500 with various information in a different format that can represent a specific aspect or perspective. This can be used to change access management process, policy, or tool to secure resources.

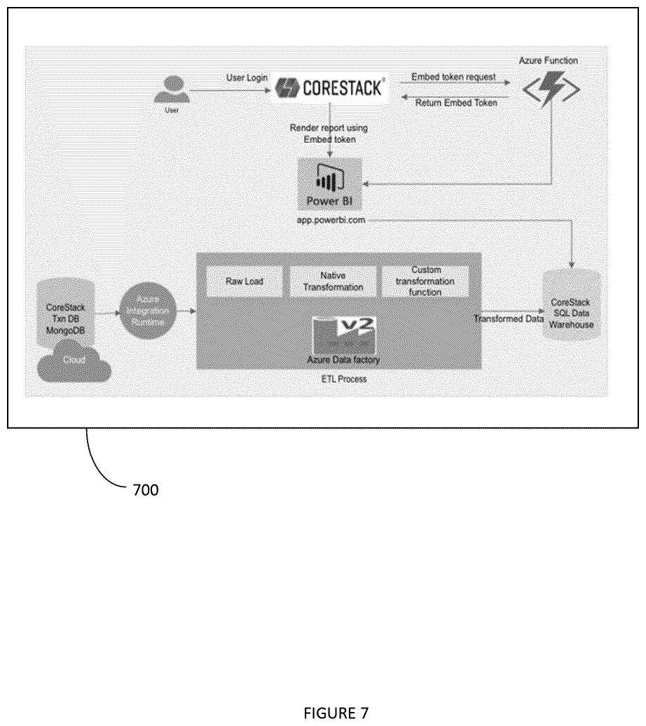

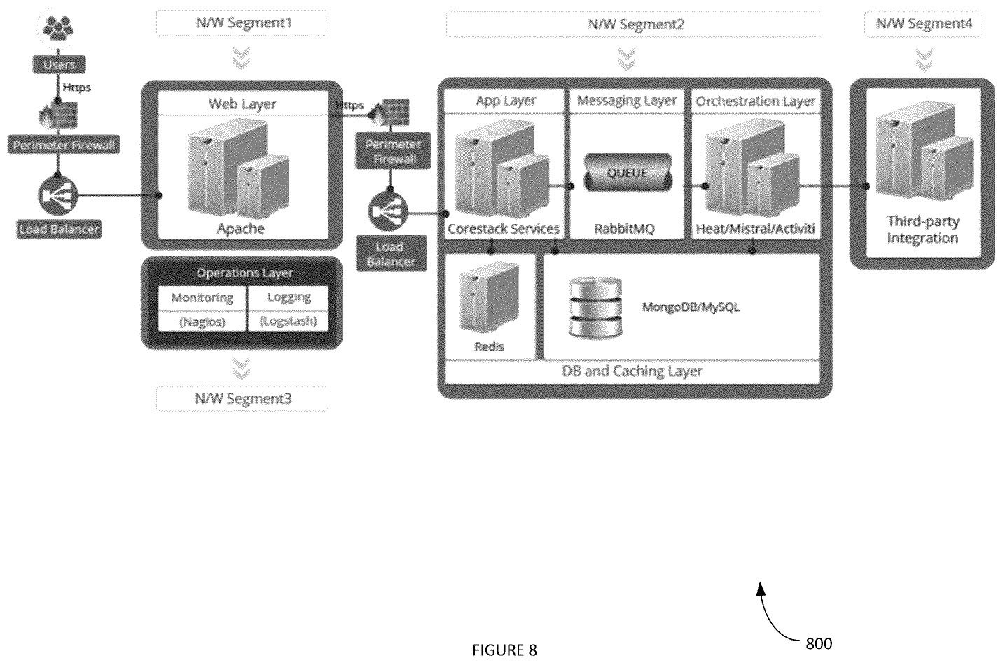

SecOps system 500 can implement compliance reports. SecOps system 500 can generate various compliance reports. These compliance reports can provide various views of compliance posture and compliance configurations. In one example, there are two types of reports. Compliance reports can provide the information compliance configuration, compliance violations, aging and recommendations. Compliance standard assessment report can provide the compliance status for each compliance standard such as FedRAMP High, ISO 27001, HIPAA or SOC2 as PDF reports. Reports can be implemented using PowerBI, Azure functions, Azure Data factory and SQL DB. FIG. 7 is a diagram 700 representing the interaction of functions relevant to reports, according to some embodiments. FIG. 8 illustrates an example SecOps deployment architecture 800, according to some embodiments.

Additional Secops Methods

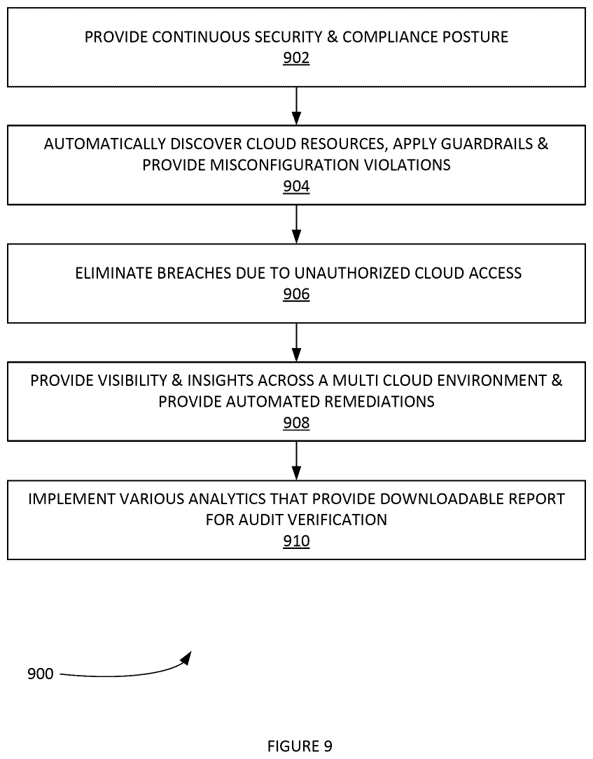

FIG. 9 illustrates an example SecOps process 900, according to some embodiments. In step 902, SecOps process 900 can provide continuous security and compliance posture. This helps an organization with their security and compliance requirements.

In step 904, SecOps process 900 can automatically discover cloud resources, apply guardrails to ensure that all the organization security requirements are applied right at the creation of resources and provide the misconfiguration violations. This can help organizations to enforce security requirements ahead of time thus reducing the cost of security and compliance.

In step 906, SecOps process 900 can be used to eliminate breaches due to unauthorized cloud access. There can be a gain continuous visibility of access and violations by discovering access definitions and utilizations.

In step 908, SecOps process 900 can provide visibility and insights across a multi cloud environment and provide automated remediation(s) options to fix the misconfigurations (e.g. in a quicker time).

In step 910, SecOps process 900 can implement various analytics that provide downloadable reports which can be shared for audit verification. These can be security maturity assessment report(s). Security maturity assessment reports can provide the actionable insights and present the misconfigurations, vulnerability, and threats in multiple perspectives.

Example Use Cases

SecOps systems and processes can be used for compliance standards assessment. This use case assesses the cloud compliance status real-time against the standards and best practices relevant to your organization. SecOps systems and processes can provide a wide range of pre-defined standards which can help in achieving Compliance and Security standards. These are pre-loaded for all subscriptions and can be executed on-demand or scheduled. These standards are available across all tenants and are created by the product administrator. It is managed by SecOps systems and processes. In on-premises installations, it can be managed by the on-site administrator. The compliance standards assessment allows the users to choose the defined industry or regulatory standards such has ISO 27001 or PCI DSS or HIPAA and then assess the controls against the resources in the multi-cloud accounts. SecOps systems and processes can provide a unique Abstracted Cloud Compliance Controls (AC3) framework that allow the organizations to assess once and comply with multiple compliance standards. Each standard can have more than one automated control which will have one of more policies (e.g. as detective guardrails) mapped. The assessment can be done at standard level or at the control level or at the policy level.

SecOps systems and processes can be used for continuous control monitoring. This use case monitors the cloud controls continuously using compliance controls and guardrails. Compliance controls can be individual rules which are enforced by the regulatory or industry specific organizations. The controls defined at each regulatory or industry standards level are classified into either process or technical controls. Process controls are automatically classified as Manual controls. Technical controls would be further divided into either manual or automated based on the technical feasibility of developing detective controls. The automated controls can be monitored via detected guardrails which will be executed automatically based on schedule defined at the standard level. The assessment results are presented via dashboard as well as in the maturity report to provide the security and compliance posture of the cloud accounts and resources.

SecOps systems and processes can be used for determining vulnerability posture and insights. This use case provides the posture of vulnerabilities and actionable insights to security operations time to prioritize the vulnerability management activities. Vulnerabilities are discovered by Vulnerability assessment solution(s) (e.g. such as AWS inspector, Nessus and Qualys integrated with Azure cloud defender, etc.). SecOps systems and processes can pull these vulnerability data from vulnerability sources and then map it with respective cloud account. The insights can provide the topmost critical vulnerabilities, aging vulnerabilities, and resource type aggregated count of vulnerabilities.

SecOps systems and processes can be used for implementing configuration violation. The configuration violations and/or misconfiguration of cloud-based services are detected by policies (detective guardrails). The policies are native policies such as AWS config rules of Azure policies and the custom policies developed (e.g. provided by SecOps systems, etc.). The configuration violation insights can provide multiple perspectives. The perspective can be geo-region and/or subclassification and/or resource category level. The configuration violations can be auto remediated by SecOps systems and processes based on the setup during the account setup or it could be remediated by user actions through a SecOps system Recommendations UI.

SecOps systems and processes can determine an access violations identity and implement access management. The identities are the IAM users and service accounts. The access can be given to IAM users and service accounts through IAM policies or IAM roles. The IAM policies and roles can be attached IAM groups. Then, IAM users can be made as members of IAM groups to obtain the access to resources in cloud accounts. The access violations could be too much of privileges for a role or group, just in time access, expired credentials or empty IAM groups and IAM users not having right group or role. SecOps systems and processes can detect these access violations through policies (detective guardrails) and reports the violations in different perspective. SecOps systems and processes can use these perspective and access postures for various operations. For example, access can be analyzed, reviewed, and remediated through Recommendation UI or manually through cloud service consoles.

Additional Example Computer Architecture and Systems

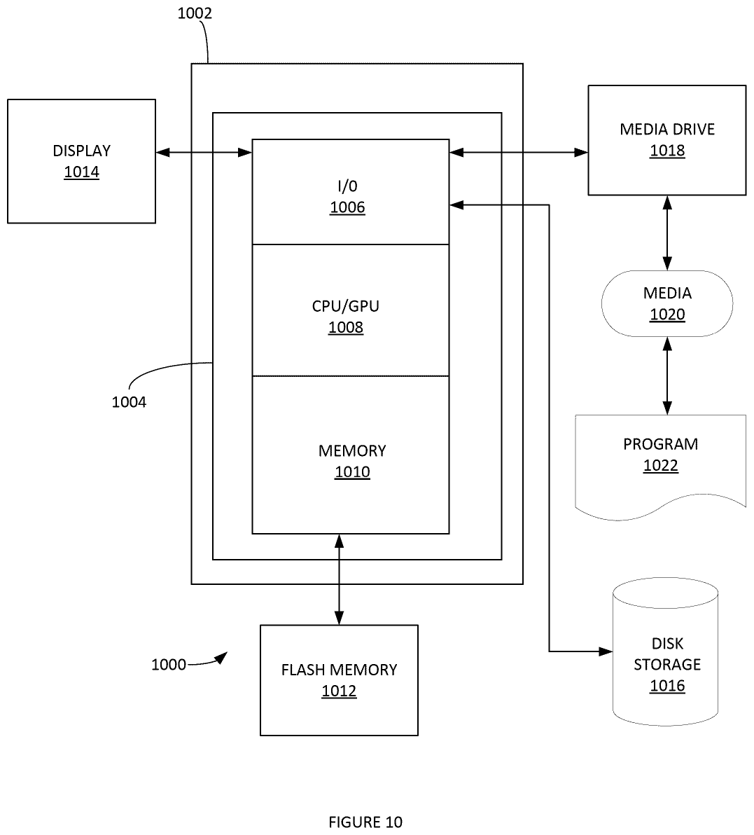

FIG. 10 depicts an exemplary computing system 1000 that can be configured to perform any one of the processes provided herein. In this context, computing system 1000 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized method for implementing a plurality of cloud-based SecOps for one or more cloud-computing platforms comprising:
maintaining a plurality of cloud-based SecOps compliance rules;
determining a SecOps compliance posture based on the plurality of cloud-based SecOps compliance rules;
implementing a security posture based, in part, on the cloud-based SecOps compliance;
implementing a plurality of continuous checks on a security posture of the plurality of cloud accounts, wherein the security posture provides visibility on a plurality of aspects across each cloud-based account;
determining and providing a threat security posture;
implementing an inventory posture for visibility operations by providing a visibility and control over a plurality of cloud-based resources spread across each entity's cloud-based account by automatically discovering plurality of cloud-based resources as a cloud-based inventory of each entity's cloud-based accounts that are on-boarded into the cloud-computing platform; and
implementing an access posture, wherein the access posture is used to provide a right access to a correct entity for one or more assets in each entity's cloud-based account.

2. The computerized method of claim 1 further comprising:
wherein the step of determining the SecOps compliance posture comprises maintaining a plurality of security postures for one or more provisioned resources.

3. The computerized method of claim 2 further comprising:
wherein the step of determining the SecOps compliance posture comprises managing and activating a plurality of policies to optimize resource utilization.

4. The computerized method of claim 3, wherein the plurality of the cloud-based SecOps compliance rules comprises a plurality of compliance controls for each rule.

5. The computerized method of claim 5 further comprising:
classifying the plurality of the cloud-based SecOps compliance rules to manual or automated controls; and
providing a plurality of automated controls through the plurality of the cloud-based SecOps compliance rules to obtain a continuous compliance posture of each cloud account.

6. The computerized method of claim 5, wherein the plurality of the cloud-based SecOps compliance rules are used to assess a security of cloud-based infrastructure and application using a plurality of cloud platform's native security assessment tools or third-party assessment tools.

7. The computerized method of claim 6, wherein an operations team obtains a consolidated compliance posture in a dashboard view.

8. The computerized method of claim 7, wherein the operations team performs an assessment after remediating a detected violation.

9. The computerized method of claim 8, wherein the step of determining and providing a threat security posture comprises:
obtaining a plurality of security alerts and threats that originate from one or more cloud native threat management services.

10. The computerized method of claim 9, wherein the step of determining and providing a threat security posture comprises:
determining and providing a vulnerabilities security posture that is derived from a plurality of vulnerability assessments of a plurality of workloads running in the cloud-computing platform and wherein the plurality of vulnerability assessments fetched from a plurality of cloud-native services.

11. The computerized method of claim 10, wherein the step of determining and providing a threat security posture comprises:
determining and providing a guardrail findings security posture.

12. The computerized method of claim 11, wherein a plurality of guardrails of the guardrail findings security posture comprises a plurality of rules governing a security best practices for each cloud resource in the cloud-computing platform.

13. The computerized method of claim 12, wherein implementing the access posture comprises:
providing the access governance posture for each asset such that there is visibility on any access related violations to standards and best practices. While managing multiple cloud accounts across cloud platforms, it is critical to have visibility on such non-compliant access and restrict them in time.

14. The computerized method of claim 13, wherein the step of providing the access governance posture for each asset such that there is visibility on any access related violations to standards and best practices is performed while managing a plurality of cloud-based accounts across a plurality of cloud-based platforms.

15. The computerized method of claim 14 further comprising:
providing a plurality of access posture of cloud-identity resources.

16. The computerized method of claim 15, wherein the plurality of access posture of cloud-identity resources comprises: IAM (Identity Access Management) users, IAM roles and IAM groups against a set of access best practices and standards.
